(19) United States
(12) Patent Application Publication
(10) Pub. No.: US 2002/0071434 A1
(43) Pub. Date: Jun. 13, 2002

(54) Data transmitting apparatus, data transmitting method, and program recording medium

(76) Inventor: Minoru Furukawa, Chiba (JP)

Correspondence Address: Sonnenschein, Nath & Rosenthal, P. O. Box 061080, Wacker Drive Station - Sears Tower, Chicago, IL, 60606, US

(21) Appl. No.: 10/002,646

(22) Filed: Oct. 31, 2001

(30) Foreign Application Priority Data
Nov. 6, 2000 (JP) P2000-337396

(51) Int. Cl. H04L 12/28; H04J 3/16

(52) U.S. Cl. 370/392; 370/465

(57) ABSTRACT

A system capable of transmitting data in accordance with importance degree of data to be transmitted and received is provided. In the case of transmitting an IP packet of an MPEG picture, for example, as data which are transmitted by way of a network, a priority in accordance with an importance degree is set as header information by identifying which one of I picture, P picture, and B picture of an MPEG picture is contained in the packet. To put it in concretely, in the case in which the packet contains the I picture having a high importance degree at the time of reproducing MPEG, a bit is set in TOS by setting the priority, which is set in a TOS field of the IP header, as a high priority and by setting as a low priority for the case in which data in the packet are B pictures only. The possibility of disappearance and delay of the I picture having the high priority is reduced in the network, and it comes to be possible to accurately reproduce in the side of receiving.

### BACKGROUND OF THE INVENTION

1. Field of the Invention

The present invention relates to a data transmitting apparatus, a data transmitting method, and a program recording medium. More particularly, it relates to the data transmitting apparatus, the data transmitting method, and the program recording medium, which are capable of preventing degradation of quality of data transmission by performing transmitting processing in accordance with an importance degree for a procedure of transmitting mixed data having different importance degrees.

2. Description of the Related Art

Presently, various types of data transmission are performed by way of a variety of telecommunicating media such as Internet telecommunication. Recently, transmission by way of a network of a moving picture, especially moving picture data, is performed prosperously. The picture data, especially moving picture data, are usually reproduced by decreasing the volume of data by way of coding (compression) processing in the side of transmission and then performing decoding (expansion) processing in the side of receiving.

For the best known method of picture compression processing, there is MPEG (Moving Picture Experts Group) compressing technology. It is expected that picture data transmission, in which an MPEG stream generated by this MPEG compression is transmitted to the Internet by storing in the IP packet conforming to IP (Internet Protocol), will be prosperous in a rapid manner in the future.

In the case in which the compressed picture represented by MPEG and so forth is transmitted using the IP network, a packet is transmitted in most cases using RTP (Real-Time Transport Protocol) protocol which has information in relation to a data coding method and a time stamp as header information and is capable of transmitting and receiving data in a real time manner. However, the IP network is a network that is not guaranteed in general. Further, it is found that the packet is damaged by an error in a transmission path and the packet is dropped.

The compressed picture has a portion, an I picture for MPEG, for example, which has especially important information when the picture is structured for the format thereof. Thus, in the case in which the packet, which contains this important portion, is lost because of an error and so forth, a very large damage is caused for the image. To put it concretely, in the case in which the I picture of MPEG picture, for example, is lost, it comes to be impossible to recover before and behind several flames thereof.

On the other hand, in recent days, a highly added value type network, which provides CoS (Class of Service) and/or QoS (Quality of Service) which guarantee quality of data transmission on the network, has comes to be real. These services are, however, still cost high in general. Further, a user of the network cannot help confronting with a trade-off between a low cost network with low reliability and a high cost network with high reliability.

### SUMMARY OF THE INVENTION

It is an object of the present invention to provide a data transmitting apparatus and a data transmitting method, which allows degradation of quality of receiving data to be minimized even if such an error as packet disappearance is caused on a network when data transmitting processing in accordance with an importance degree is performed for transmitting data mixing data having different importance degrees as data to which MPEG compression, for example, is performed.

According to one aspect of the present invention, there is provided a data transmitting apparatus, which includes: packet generating means for generating transmitting data as a packet in accordance with a communications protocol; in which packet generating processing is performed by identifying an importance degree of data stored in each packet and setting priority information in accordance with the importance degree to be identified in header information.

Further, in an embodiment of the data transmitting apparatus of the present invention, the packet generating means sets the importance degree of data, in which high priority information is set to data containing reference information from other data as data having high importance degree and low priority information is set to data not containing reference information from other data as data having low importance degree.

Still further, in an embodiment of the data transmitting apparatus of the present invention, data to be stored in a packet generated by the packet generating means are MPEG data, and the packet generating means performs packet generating processing by setting priority information, which indicates which one of I picture, P picture, and B picture forming MPEG data is contained in data stored in each data packet, in header information.

Still further, in an embodiment of the data transmitting apparatus of the present invention, the packet generating means performs IP packet generating processing by setting priority information in accordance with importance degree of data stored in each IP packet in a priority information setting field of an IP header in accordance with IP (Internet Protocol).

Still further, in an embodiment of the data transmitting apparatus of the present invention, priority information to be set by the packet generating means corresponds to service quality in accordance with QoS (Quality of Service).

Still further, in an embodiment of the data transmitting apparatus of the present invention, priority information to be set by the packet generating means corresponds to a selecting standard of any one of a guarantee type for band width assurance data transmission and a best effort type for band width non-assurance data transmission.

Further, according to another aspect of the present invention, there is provided a data transmitting method, which includes: a packet generating step for generating transmitting data as a packet in accordance with a communications protocol; in which the packet generating step executes a procedure of identifying importance degree of data stored in each packet and setting priority information in accordance with the importance degree being identified in header information.

Still further, in an embodiment of the data transmitting method of the present invention, the packet generating step defines importance degree of the data, in which high priority information is set to data containing reference information from other data as data having high importance degree and low priority information is set to data not containing reference information from other data as data having low importance degree.

Still further, in an embodiment of the data transmitting method of the present invention, in which data to be stored in a packet generated by the packet generating step are MPEG data, and the packet generating step executes packet generating processing by setting priority information, which indicates which one of I picture, P picture, and B picture forming MPEG data is contained in data stored in each data packet, in header information.

Still further, in an embodiment of the data transmitting method of the present invention, in which the packet generating step executes IP packet generating processing by setting priority information in accordance with importance degree of data stored in each IP packet in a priority information setting field of an IP header conforming to IP (Internet Protocol).

Still further, in an embodiment of the data transmitting method of the present invention, priority information to be set by the packet generating step corresponds to service quality in accordance with QoS (Quality of Service).

Still further, in an embodiment of the data transmitting method of the present invention, priority information to be set by the packet generating step corresponds to a selecting standard of any one of a guarantee type for band width assurance data transmission and a best effort type for band width non-assurance data transmission.

Moreover, according to still another aspect of the present invention, there is provided a program recording medium for providing a computer program for executing data transmitting processing on a computer system, in which the computer program comprises: a packet generating step for generating transmitting data as a packet in accordance with a communications protocol; and the packet generating step contains a step of identifying importance degree of data stored in each packet and setting priority information in accordance with the importance degree being identified in header information.

At this point, the program recording medium in accordance with the above aspect of the present invention is a medium in which a computer program is provided in a computer-readable form for a general purpose computer system capable of processing a variety of program codes, for example.

These program recording media define a cooperative relationship of a function or a structure between the computer program and the recording medium in order to make real the function of the prescribed computer program on the computer system. In other words, it is possible to obtain the same operation and results as other features of the present invention since the cooperative operation is effective on the computer system by installing the computer program in the computer system by way of the recording medium.

In accordance with the data transmitting apparatus, the data receiving apparatus, the data transmitting method, and the program recording medium of the present invention, since the structure, in which a priority in accordance with a data type stored in the packet is stored in header information of the data packet in which data are set and then the priority is sent to the network, is formed, in the side of data transmission, the packet containing important information is processed in a priority manner, the case, in which the packet is destroyed on the way and a delay of transmission is caused, is avoided, and it is made real to reproduce the packet in the side of receiving data as a procedure in which any error is not caused.

Further, in accordance with the data transmitting apparatus, the data receiving apparatus, the data transmitting method, and the program recording medium of the present invention, since the structure is formed, in which the priority is set by judging whether or not an I picture, a P picture, and a B picture are contained in a header information of a data packet which stores data as stored data of the packet and the priority is sent to the network, processing for transmitting MPEG compressed data, the I picture, for example, which contains important information, is processed in a priority manner, the case, in which the picture is destroyed on the way and a delay of transmission is caused, is avoided, and it is made real to reproduce the picture in the side of receiving data as a procedure in which any error is not caused.

### BRIEF DESCRIPTION OF THE DRAWINGS

FIG. 1 illustrates a general diagram of the structure of a system of the present invention.

FIG. 2 is an explanatory view of forms of MPEG picture data.

FIG. 3 is an explanatory view of forms for referring MPEG picture data.

FIG. 4 is a block diagram of the structure of a PCI board for MPEG processing of the present invention.

FIG. 5 illustrates the structure of an RTP header of an IP packet transmitted by the system of the present invention.

FIG. 6 illustrates the structure of a UDP header of the IP packet transmitted by the system of the present invention.

FIG. 7 illustrates the structure of a TCP header of the IP packet transmitted by the system of the present invention.

FIG. 8 illustrates the structure of an IP header of the IP packet transmitted by the system of the present invention.

FIG. 9A and FIG. 9B illustrate the structures of information of priorities of the IP header of the IP packet transmitted by the system of the present invention.

FIG. 10 is an explanatory view of the structure of processing for setting information of the priority of the packet transmitted by the system of the present invention.

FIG. 11 is an explanatory view of the structure of a network for transmitting the IP packet transmitted by the system of the present invention.

FIG. 12 is an explanatory view of an example of processing by a router based on the priority of the IP packet transmitted by the system of the present invention.

FIG. 13 is a flowchart of explaining packet generating processing for setting the priority in the side of transmitting the IP packet transmitted by the system of the present invention.

FIG. 14 is a flowchart of explaining processing in the side of receiving the IP packet transmitted by the system of the present invention.

### DESCRIPTION OF THE PREFERRED EMBODIMENTS

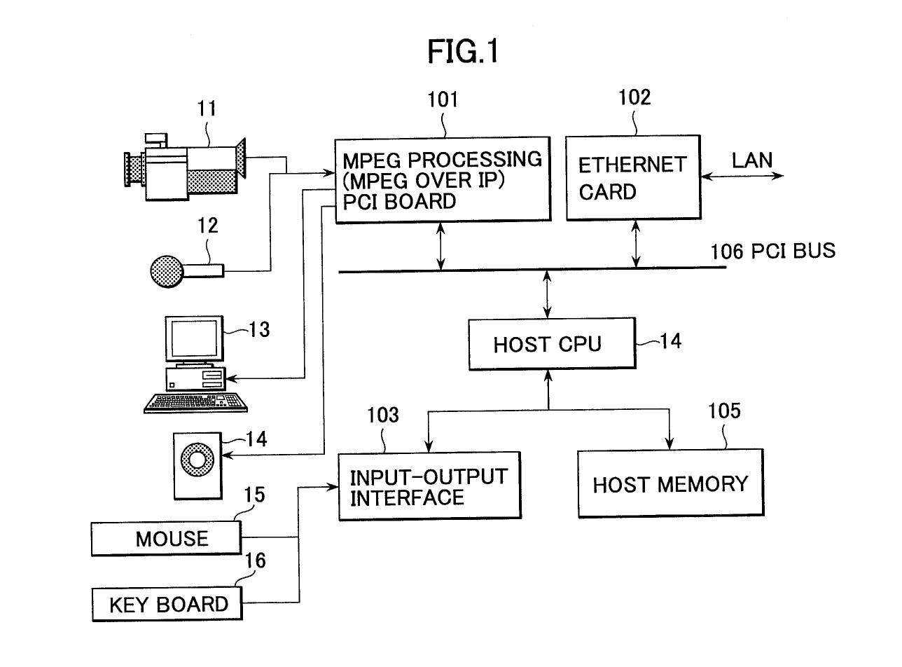

FIG. 1 is a block diagram of the embodiment of a data transmitting apparatus of the present invention. In this embodiment, though the embodiment which applies data, especially MPEG2, compressed by MPEG (Moving Pictures Experts Group) as a general purpose compressing type format as transmitting data, it is also available to apply another compressing method, MPEG4, for example.

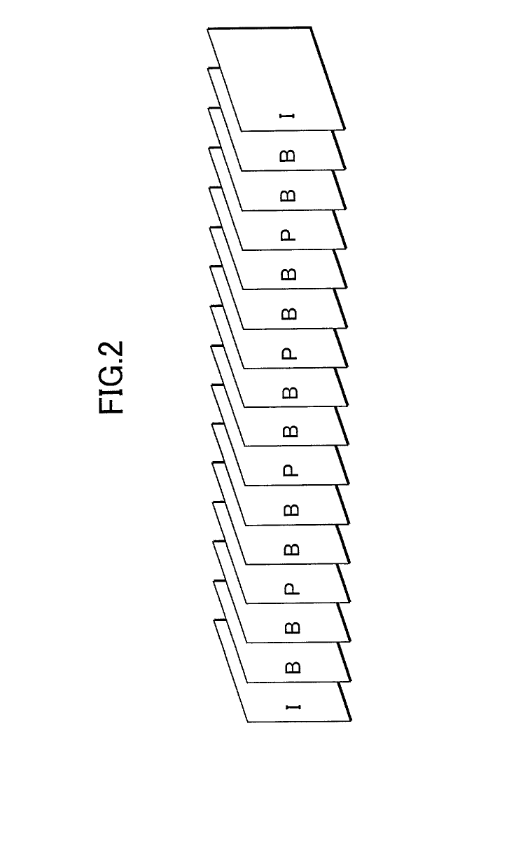

MPEG2 is the technology of allowing high quality picture compressing processing to be real. The compressing method of MPEG2 which has been employed at the present time is a compressing method which is a combination of a Huffman code as compression based on correlation of code lines, motion-compensation as compression based on correlation between screens, and a discrete cosine transformation (Discrete Cosine Transform: DCT) as compression using correlation of a screen. MPEG2 employs a GOP (Group of Pictures) structure of 3 elements which are called an I picture, a P picture, and B picture as shown in FIG. 2 in order to perform predicting encoding using motion-compensation.

The I picture (Intra encoding picture) is created by encoding in a field and the I picture means a picture data for not performing predicting encoding from the prior picture. If pictures only, which are created using predicting encoding, are arranged, at the time that random access is performed, the screen cannot display instantaneously corresponding therewith. Thus, it has been made possible to correspond to a random access by creating an object as a standard for accessing regularly. So to speak, the I picture exists in order to keep independency of GOP.

The frequency of occurring the I picture is defined by the nature of random access that is required to each application, the ratio thereof is normally 1 sheet per 1 field (2 sheets per 1 flame), that is to say, 1 sheet per 15 sheet pictures. The volume of data for 1 sheet I picture corresponds to 2 to 3 times as large as 1 sheet P picture and 5 to 6 times as large as 1 sheet B picture. GOP means a group of pictures each of which is between one I picture to the next I picture. Thus, it is performed to predict a picture between pictures of this group.

The P picture (Predictive coded picture) is a picture which is made by performing predictive coding from a past reference picture and made using the I picture. The I picture is defined as “coded picture in a flame.” On the other hand, the P picture is defined as “forward predictive coded picture between flames.”

The B picture (Bidirectionally predictive coded picture) is a “bidirectionally predictive coded picture.” The B picture is made by predicting back-to-front 2 I pictures or P pictures.

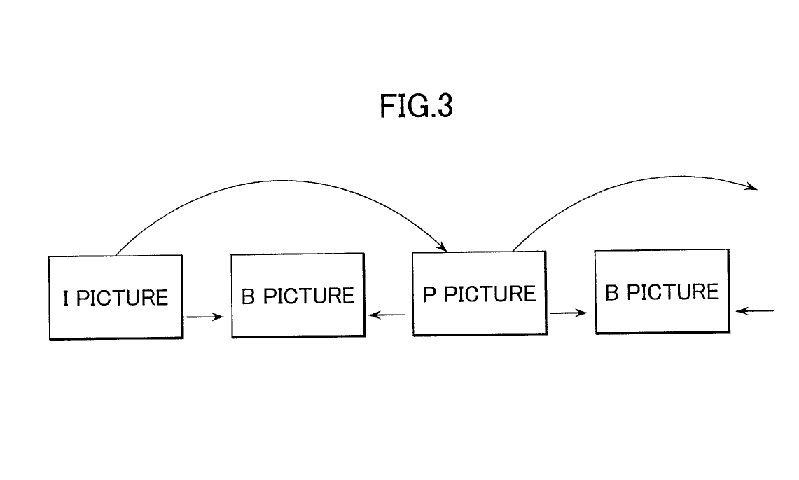

The case of arranging the I picture, the P picture, and the B picture in GOP is shown in FIG. 3. The first prediction from the I picture located in the top position of GOP is performed ahead, namely, in the forward direction, and then the P picture is created. At this stage, the P picture is allocated in such a way as jumping over more than one B picture which will be created in the future.

For the second prediction, more than one B picture is created between 2 sheets from 2 sheet P pictures encoded by the first I picture and the first step, namely, by way of a bidirectional prediction. Moreover, in the same way, more than one picture is created between the first P picture and the second P picture. Motion-compensation is performed to the B picture using 2 motion vectors and 2 (front and back) sheet reference pictures at the time of decoding. The bidirectional prediction as a featured point of MPEG is characterized in that it is possible to achieve a high prediction effect because 2 pictures of the past picture and the future picture in view of time are used for the prediction.

In this embodiment, data compressed by MPEG2 are transmitted to a network as an IP packet (MPEG over IP). Thus, in the side of transmitting data, a packet generation (packetizing processing) is performed. In the side of receiving data, a packet expansion (depacketizing processing) is performed.

A data transmit-receive apparatus 100 of the present invention in FIG. 1 includes an MPEG processing PCI board 101 for performing a packet generation and an expansion process while performing MPEG compression and expansion, an MPEG processing PCI board 101 for performing expansion processing, an Ethernet card 102 which functions as an interface with LAN as a telecommunication network, an input-output interface 103 with a mouse 15 and a keyboard 16, data processing in the MPEG processing PCI board 101, data telecommunication processing byway of the Ethernet card 102, a host CPU 104 for controlling processing for input data, etc. by way of the input-output interface 103, and a host memory 105 having ROM and RAM functioning as a work area of the host CPU 104 and for storing a variety of programs controlled and processed by the host CPU 104 and storing data. Each of the MPEG processing PCI board 101, the Ethernet card 102, and the host CPU 104 is connected to the PCI bus 106 and has a structure capable of transmitting and receiving data with each other.

The MPEG processing PCI board 101 inputs, as shown in FIG. 1, for instance, picture data from a video camera 11 and voice data from a microphone 12, executes MPEG2 compression processing, code multiplex processing, packet generation processing (packetize), and finally generates an IP packet which stores MPEG transport stream (TS) data. A generated IP packet is output to a PCI bus 106, output to LAN by way of the Ethernet card 102, and then distributed to an destination address set in a header of the IP packet.

Further, MPEG transport stream (TS) data, which are processed in an IP packet way, for inputting by way of LAN are output to the PCI bus 106 by way of the Ethernet card 102, and then input to the MPEG processing PCI board 101. The MPEG processing PCI board 101 executes packet expansion processing (depacketize) of input data, after MPEG compression data are extracted, decoding processing is performed, and then a display 13 and a speaker 14 regenerates and outputs them.

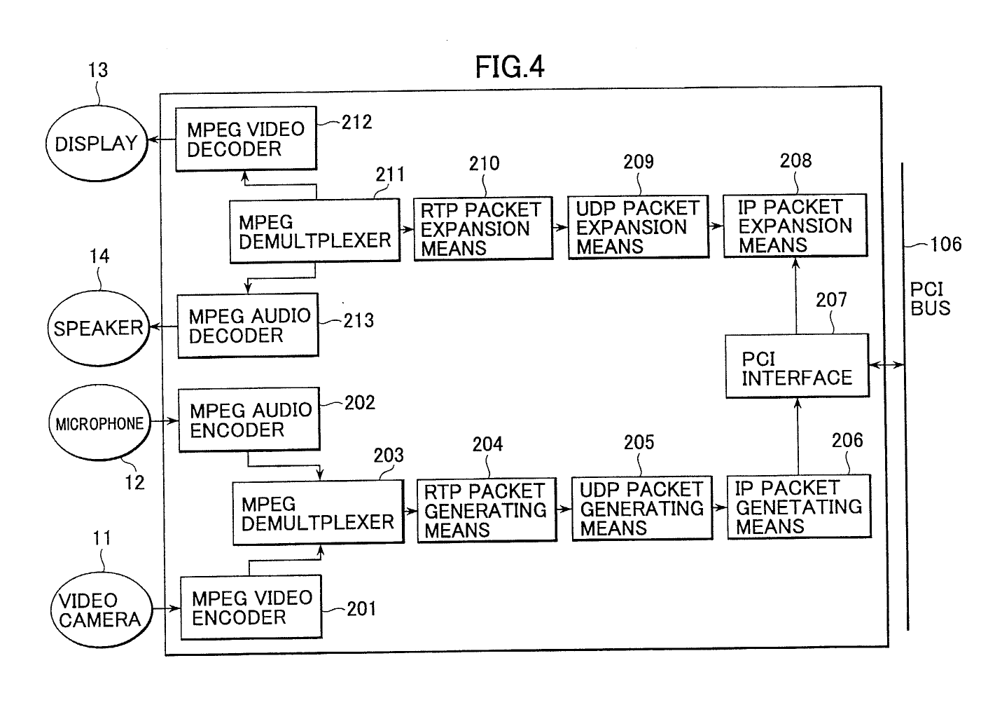

The structure of the MPEG processing PCI board 101 is shown in FIG. 4. Moving picture data input from the video camera 11 is input to an MPEG2 video encoder 201. The video encoder 201 generates an MPEG video stream based on input moving picture data. Further, voice data input from the microphone 12 are input to an MPEG2 audio encoder 202. The audio encoder 202 generates an MPEG audio stream based on input voice data.

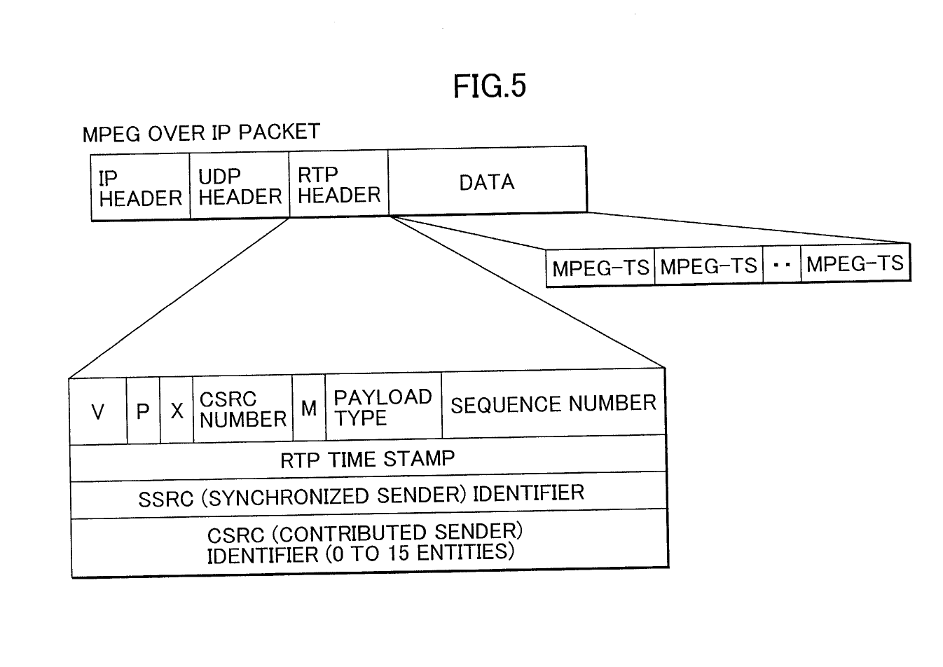

For the MPEG2 video encoder 201 and the MPEG2 audio encoder 202, these 2 streams are input to an MPEG multiplexer 203 and multiplexed as an MPEG2 transport stream. The transport stream (TS) is a packet stream each of which is a packet stream bundled by the prescribed data quantity, and more than one MPEG-TS packet (referring to FIG. 5) is contained in an IP packet such as LAN, which is output to a network.

In the RTP packet generating means 204, an RTP packet is generated by adding a RTP header to the MPEG transport stream. In the UDP (User Datagram Protocol) packet generating means 205, a UDP packet is generated by adding an UDP header to the RTP packet. In an IP packet generating means 206, an IP packet is generated by adding an IP header to the UDP packet. The MPEG transport stream generated by the MPEG multiplexer 203 is output to the PCI bus 106 by way of a PCI interface 207 and then output to the network from the Ethernet card 102 shown in FIG. 1.

In this way, an IP packet output to the network is input to an MPEG processing PCI card by way of the Ethernet card 102 and the PCI bus 106. The IP packet is input to an IP packet expansion means 208 from the PCI interface 207, and then IP packet expansion, that is to say, packet expansion processing in accordance with IP header information, is executed. In an UDP packet expansion means 209, UDP packet expansion processing is performed, and finally an MPEG2 transport stream is obtained by expansion processing in accordance with the RTP header in an RTP packet expansion means 210. The RTP packet has a time stamp described hereinafter, and a delay fluctuation and arrival order are modified and absorbed based on the time stamp.

The obtained MPEG transport stream is, in the MPEG demultiplexer 211, separated into the MPEG video stream and the MPEG audio stream, decoding processing is performed in an MPEG video decoder 212 and an MPEG audio decoder 213 respectively, and then the display 13 and the speaker 14 reproduces.

In such a data transmission as video on demand (VOD) and a video conference by way of an IP network, it is important to supply data seamlessly, thus a protocol for processing re-transmission processing such as TCP (Transmission Control Protocol) in general is not performed, but UDP for not performing re-transmission is employed. However, it is possible to transmit and receive using TCP.

UDP is so designed as to allow an application process to perform data transmission with the minimum overheads to another application on a remote machine. Thus, for information contained in the header, there are contained a sender port number, a destination port number, a data length, and the checksum only. However, there is no data field for identifying packet order in the typical manner of TCP (Transmission Control Protocol).

Thus, there are used a real time picture of the IP network and a real time transport protocol RTP (Real-time Transport Protocol) as a protocol for transmitting and receiving voice data. RTP is positioned in a transport layer and used on UDP in general.

FIG. 5 indicates in detail the RTP header of the component of the IP packet in which MPEG transport stream is packetized by RTP, UDP, and IP. In the RTP header, there is provide each field of a version number (v), padding (P), yes or no of a expanded header (x), the number of senders (CRSC: Contributing Source), marker information (M), a payload type, a sequence number, an RTP time stamp, a synchronous sender identifier, and a contributed sender (CSRC) identifier. Time for processing is controlled at the time of expanding the RTP packet by the time stamp attached by the RTP header, and thus it comes to be possible to reproduce and control a real time picture or a voice. At this point, as shown in FIG. 5, more than one MPEG transport stream as compressed data is stored in the IP packet.

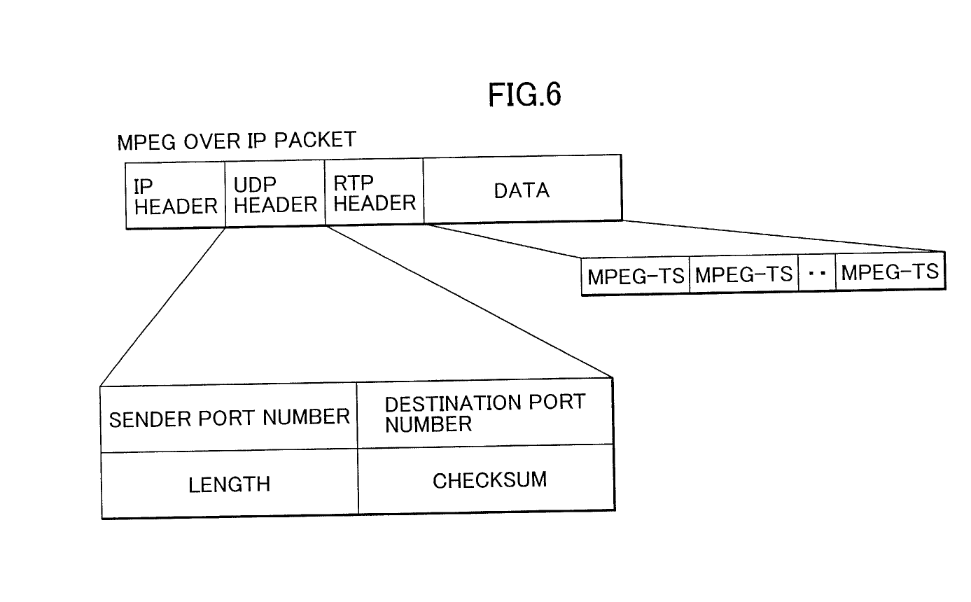

FIG. 6 indicates in detail a UDP (User Datagram Protocol) header of the component of the IP packet in which the MPEG transport stream is packetized by RTP, UDP, and IP. UDP is a protocol of providing a connectionless type service, and has a simple header structure. As indicated in the figure, in the UDP header, there are included: the header as a sender port number, a destination port number, and a data length; a length for indicating the total number of bytes for a data length; and the checksum as the value of a reliability guarantee. Since UDP has a simple structure, it comes to be easy to control.

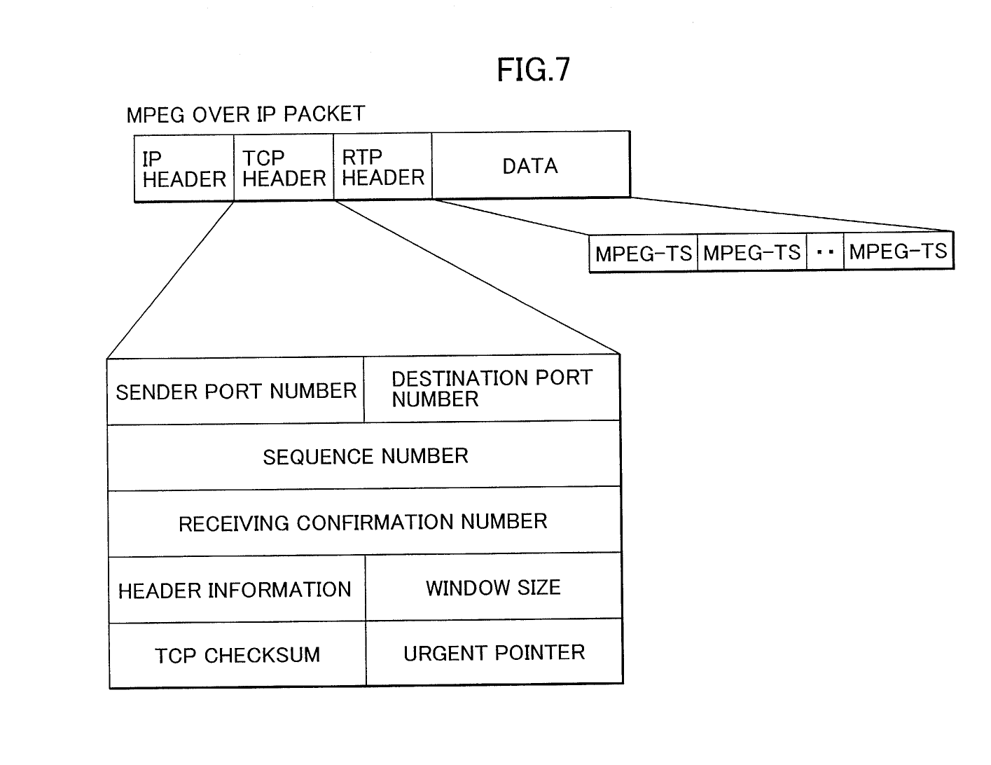

In the present invention, it is also possible to employ a TCP (Transmission Control Protocol) format not the UDP format. FIG. 7 indicates the component of an MPEG transport stream packet using TCP. The TCP header includes: a sender port number; a destination port number; a sequence number for indicating data order of indicating which number of bytes the heading position of the data packet is located at from the initial portion of data transmitted by indicating byte number; a receiving affirmation number of indicating a sending sequence number of data transmitted next from the transmitter; header information composed of a header length and code bits for the processing method of a TCP segment; a window size for indicating the number of bytes capable of receiving the rest data; the checksum as the value of a reliability guarantee of the TCP packet; and an urgent pointer to data for requiring urgent processing.

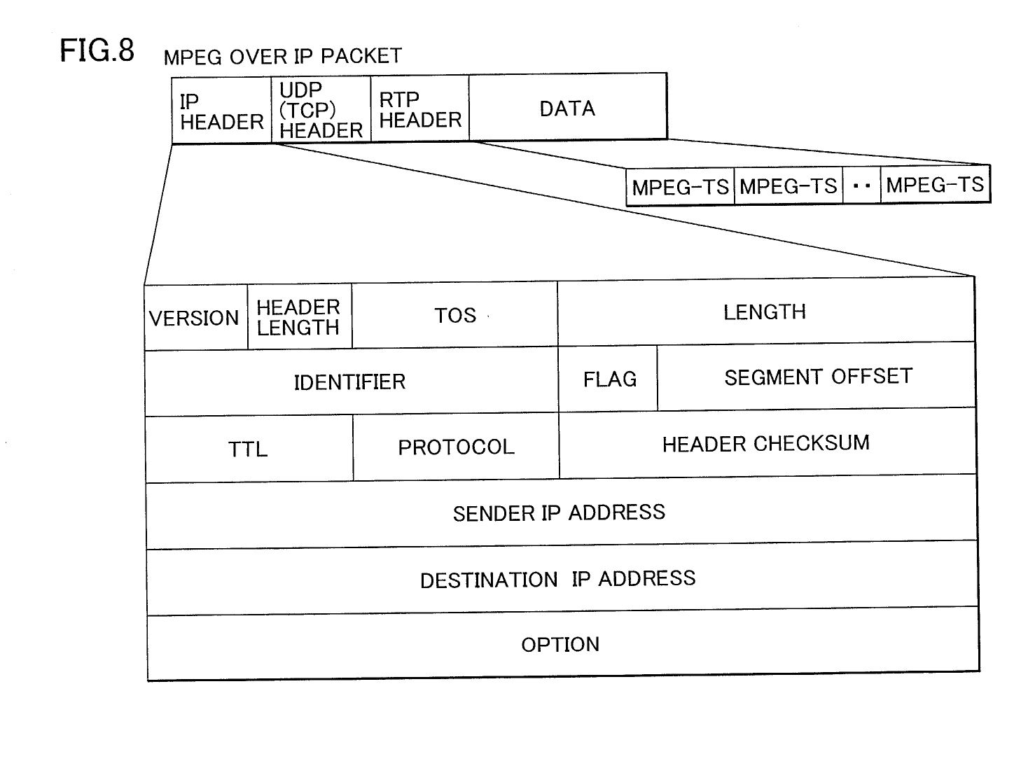

Next, FIG. 8 indicates in detail an IP header of the component of the IP packet in which the MPEG transport stream is packetized by RTP, UDP (TCP), and IP. There are included: a version of indicating such a version as IPv4 and IPv6; a header length, a TOS (Type of Service) field of containing priority information; a packet length; a packet identifier; a flag as control information for data fragmentation (fragment) in an IP layer; a segment offset for indicating a position of fragmented (fragment) data; TTL (Time to Live) for indicating information of time until data are destroyed; the checksum of a protocol (4:IP, TCP: 7, UDP:17 . . . ) header used in an upper layer; a sender IP address; and a destination IP address.

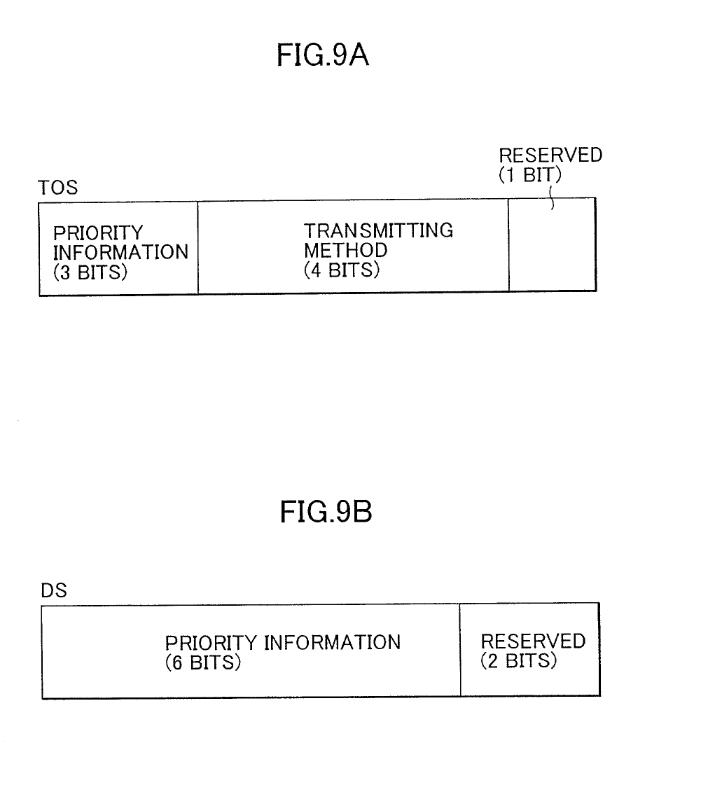

The TOS (Type of Service) field of the IP header defines a priority of data and decides the type of data which should be transmitted. FIG. 9A indicates in detail the TOS field. The TOS field has a 8 bit structure, and priority information is stored in the first 3 bits. [000] indicates no-priority. [100] indicates the highest priority. The next 4 bits are fields for indicating that what kind of transmission should be taken in accordance with the protocol of the upper layer and decides that the speed should take priority and/or that reliability should take priority in accordance with setting bits.

FIG. 9B indicates the form of DS (Differentiated Service) field that uses the TOS field in a different way and stores information. The DS field is composed of 8 bits, and priority information is set in the first 6 bits. [xxxxx0] indicates a standard usage (standard), [xxxx11] indicates an experimental or local usage. In this way, it is possible to have the format capable of defining detail priority information. At this point, for IPv4, the DS field is stored in the TOS field. On the other hand, for IPv6, it is stored in the traffic field.

For data transmission of the MPEG transport stream (MPEG-TS) of the present invention, priority information for transmitting data such as the TOS field or DS field is defined in the IP packet in accordance with a picture contained in the MPEG transport stream (MPEG-TS).

At this point, the IP header which is explained in FIG. 8 has a header format of IPv4. A priority information storing field is also provided in the header, priority information of IPv6 has a congestion-controlled type (congestion-controlled) and a non-congestion-controlled type (non-congestion-controlled). The congestion-controlled type (congestion-controlled) has priority order for controlling data transmission firmly. Priority information, from 0 to 7, is set, and high priority is set to remote-login and/or network management, for example, thus it is possible to apply to set low priority to electric mail and so forth. The non-congestion-controlled type (non-congestion-controlled) is used in a service in which real time processing is required, and priority order from 8 to 15 is set. A narrow band width is set for low priority order (ex. the priority is 8) and a wide band width is set for higher one (ex. the priority is 15). In such a case as not having enough band width, processing, in which data having the low priority (ex. the priority is 8) are cancelled but data only having higher priority are transmitted, is performed.

In packetized processing (packet generation processing) at the time of encoding processing in the MPEG processing PCI board 101 of FIG. 1, the priority is determined in accordance with the situation that which one of I picture, P picture, and B picture is contained as a picture contained in the MPEG transport stream (MPEG-TS).

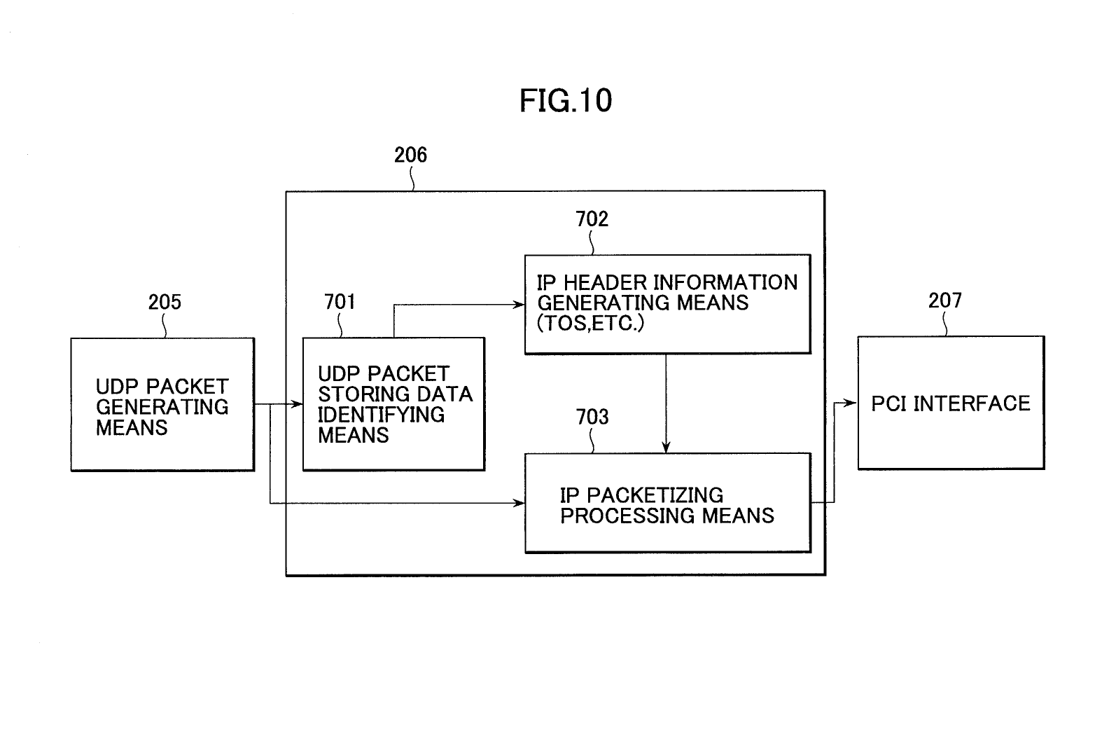

FIG. 10 is a block diagram of a processing structure for setting priority information in accordance with a storing picture type of the packet in the IP packet generating means 206. The IP packet generating means 206 receives the UDP packet from the UDP packet generating means 205. The UDP packet is the RTP packet, which stores the MPEG transport stream, as the UDP packet in which the UDP header is generated, and stores the MPEG transport stream packet in a data portion.

The UDP packet identifies the MPEG transport stream (MPEG-TS) packet which is stored in the UDP packet in a UDP packet storing data identifying means 701 of the IP packet generating means 206. Identifier is performed for identifying whether or not the I picture is contained in the stored MPEG-TS. As mentioned before, the I picture is a picture which contains reference information of other P picture and B picture and a very important picture.

In a UDP packet storing data identifying means 701, the result of deciding whether or not the I picture is contained in the packet is output to an IP header information generation means 702, and then bits having the high priority are set in the foregoing TOS or DS field if the IP picture is contained in the UDP packet. Further, in the case in which the I picture is not contained in the packet, bits having the low priority are set in the foregoing TOS or DS field.

In the IP header information generation means 702, other header information, which contains information of the priority in accordance with the picture type of the packet, is generated, the IP packet having the IP header is generated in an IP packetizing processing means 703, and then it is transmitted to the destination address by way of the PCI interface 207. At this point, in FIG. 10, respective processing blocks are indicated in a functionally separating manner. However, it is possible to execute consecutive procedures by controlling by CPU as sequential processing.

In the aforementioned case, the case, in which 2 kinds of priorities are set based on the result of judging whether or not the I picture is contained in the RTP packet, is explained. However, it may also be possible to have a form, which allows a packet containing the I picture to have the highest priority and the packet of the B picture only to have the low priority or by which further detailed information of the priority is recorded based on the number, ratio, etc. of I pictures, P pictures, and B pictures, other than such a case that these 2 kinds of priorities are set.

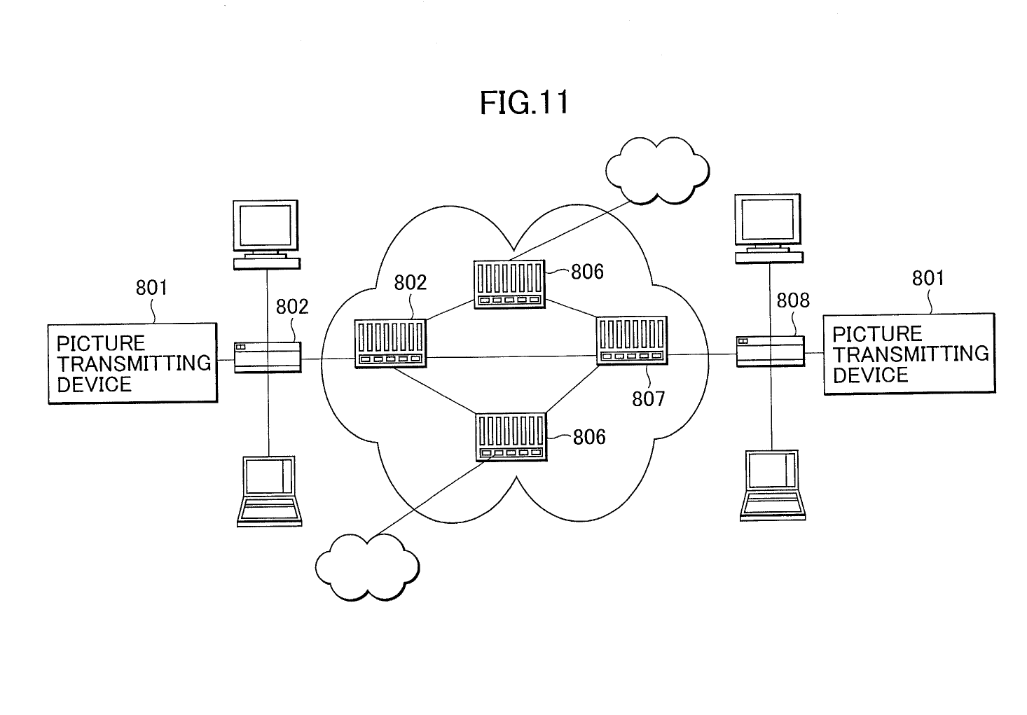

In the side of data transmission for performing data decoding and packet generation procedure, the aforementioned procedure is performed and the IP packet is transmitted to the network. The IP packet which has been transmitted to the network is transmitted towards the destination address by way of a router allocated in the network. The concept of the network is illustrated in FIG. 11.

A picture transmitting device 801 in the side of data transmission has the aforementioned machine of FIG. 1. The picture transmitting device 801 MPEG-encodes (encoding) and packetizes as explained using FIG. 4. The IP packet generated in the picture transmitting device 801 is transmitted to a network 803 such as Internet by way of a router 802. The aforementioned priority in accordance with the picture types is added to the IP packet as header information. The IP packet arrives at a router 808 corresponding to the destination address by way of plural routers 804, 805, 806, and 807 on the network, and then packet expansion and decoding (decode) processing are performed and reproduced in a picture transmitting device 809.

As shown in FIG. 11, plural routers are connected to the network and, in respective routers, data transmitting processing is performed in accordance with the destination port number of the UDP header which is set in accordance with the aforementioned priority.

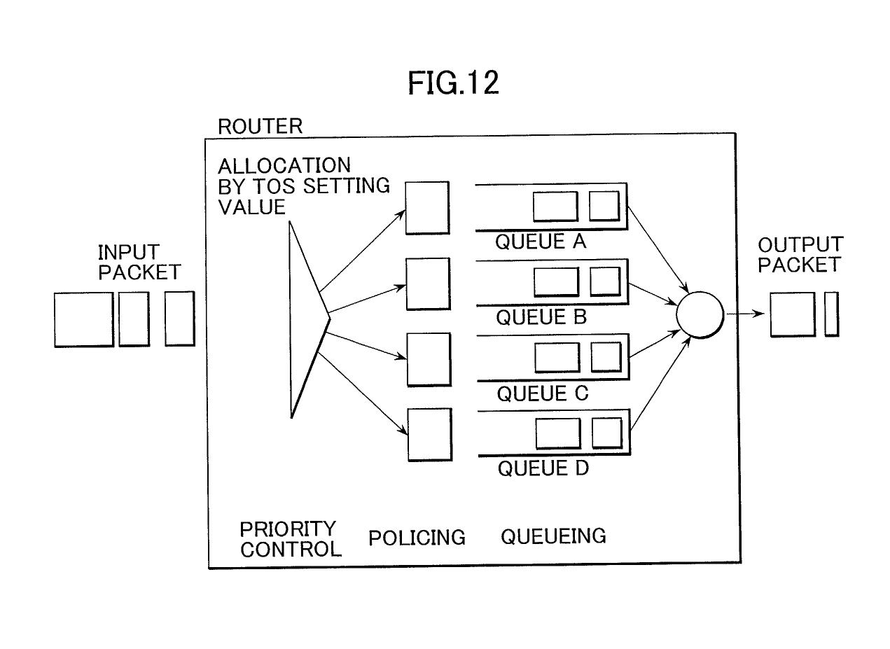

FIG. 12 is an explanatory view of a procedure in accordance with information of the priority in respective routers. For the IP packet which arrives at the router by way of the network, header information of the IP packet is read and performed in accordance with the header. Here, The procedure only in relation to the priority which is stored in the TOS field, for example, is explained.

In accordance with information of the priority stored in the header of the IP packet, each of IP packets is distributed into a queue (a line of waiting) as a different line of waiting. In the case of FIG. 12, the router has a queue partitioned into 4 priorities.

Here, it is supposed that the value of the TOS field of the IP header, for the device in the side of picture transmission, is set as follows:

Packet having the I picture: [0x03]

Packet having the P picture: [0x02]

Packet having the B picture: [0x01]

Packet other than the above: [0x00]

In the router, distributing processing in the following is performed:

in a queue A, the packet of the value [0x03] of TOS,

in a queue B, the packet of the value [0x02] of TOS,

in a queue C, the packet of the value [0x01] of TOS, and

in a queue A, the packet of the value [0x00] of TOS.

The procedure of each queue in the routers outputs packets at the ratio of 4:3:2:1 for A:B:C:D. Thus, the packets stored in the queue A are transmitted at the highest priority. Then, the queue B, the queue C, and the queue D are transmitted in order.

As a result, the packet having the I picture of setting [0x03] in TOS is processed in a highest priority manner. The packet having the P picture of setting [0x02] in TOS is processed in a next priority manner. The packet having the B picture of setting [0x01] in TOS is processed in a next priority manner. The packet not having the I, P, and B pictures of setting [0x00] is processed at the next priority. The picture transmitting device 809 (referring to FIG. 11) in the side of data receiving is capable of receiving the IP packet more firmly, which has the highest priority.

The case of a process using a queue in accordance with the priority in the router shown in FIG. 12 shows an example of processing. For another case, it is possible to give a completely different procedure in relation to data transmission, such as the speed of processing and affirmation processing of transmission authenticity, in accordance with the priority.

For a system of allocating a class and quality of data transmission, there are QoS (Quality of Service) and CoS (Class of Service). These set a peak speed, a minimum assured speed, fluctuation (transmission dispersion), and a delay for transmitting data by way of the network. It comes to be possible to transmit the packet having the high priority in all probability firmly without a delay by changing a processing mode of the router, other data transmission, and a relay method in accordance with the value (priority information) set in the DS field or the TOS field of the aforementioned IP header. Priority information of the IP header in this case has a function as information in accordance with the quality of service of QoS (Quality of Service).

Further, for data transmitting processing, there are a guarantee type transmitting procedure for assuring a band width and a best effort type transmitting procedure for not assuring the band width at the time of network congestion. Then, it comes to be possible to transmit the packet having the high priority to the destination in higher probability without any delay firmly by changing these processing modes in accordance with the value (priority information) set in the DS field or the TOS field of the aforementioned IP header. Priority information of the IP header in this case has a function as information in accordance with the selecting standard of any one of the guarantee type of transmitting data assuring the band width and the best effort type of transmitting data not assuring the band width.

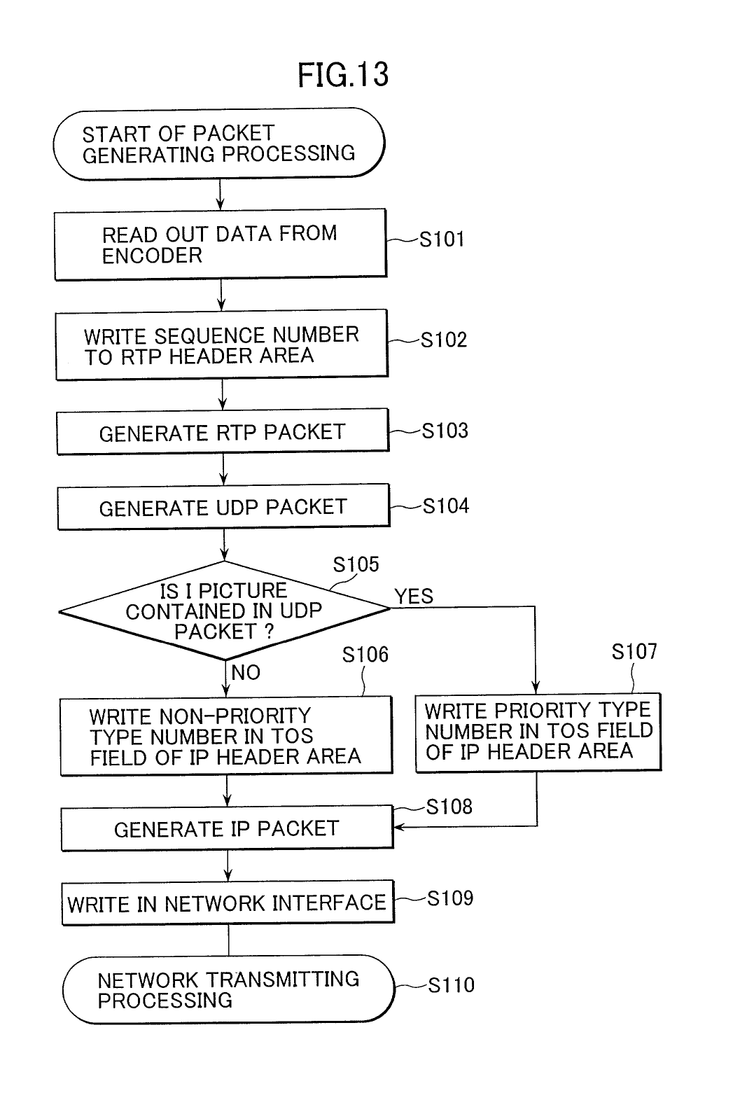

FIG. 13 is a processing flow in the side of data transmission for encoding data and packetizing. The processing flow of FIG. 13 is herein explained.

First of all, data are encoded (encoding) in the MPEG2 video encoder 201 and the MPEG audio encoder 202 shown in FIG. 4. Then, the MPEG transport stream generated in the MPEG multiplexer 203 is input to the RTP packet generating means 204 (S101). Then, header information of a sequence number, etc. is written (S102) in the RTP header and the RTP packet is generated (S103) in the RTP packet generating means 204 Then, the RTP packet is input to the UDP packet generating means 205, and next in time the UDP packet is generated (S104) by adding the UDP header.

Next, the UDP packet is input to the IP packet generating means, and it is performed to determine whether or not the I picture is contained in the UDP packet (S105). At this point, the case, in which 2 kinds of packets are examined by determining whether or not the I picture is contained in the packet, is shown here.

In the case in which the I picture is contained in the packet, a step S107 is executed and a type number (bit) having the high priority is set in the TOS field of the IP header. Further, in the case in which the I picture is not contained in the packet, a step S106 is executed and a type number (bit) having the low priority is set in the TOS field of the IP header.

The IP packet is generated at a step S108 when IP header information containing the TOS field is generated. The generated IP packet is written in the PCI interface 207. These processes for the MPEG transport stream read out from the encoder are executed sequentially. The generated IP packet is written in the PCI interface, and then it is output to the network (S110).

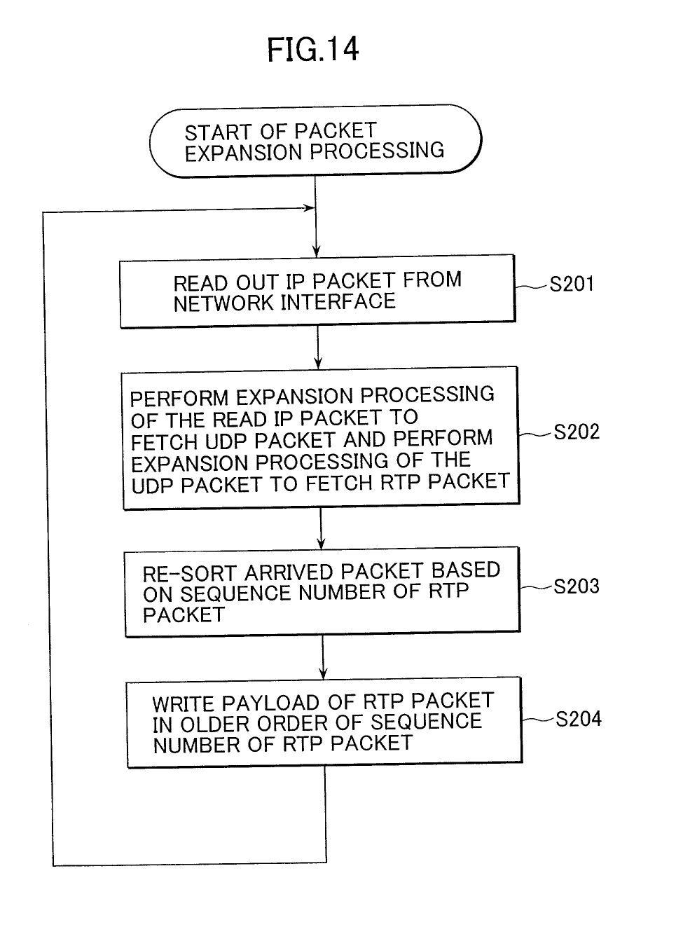

FIG. 14 indicates a processing flow of the receiving device of receiving the IP packet thereof. The processing flow is explained with reference to FIG. 4. The IP packet which is received from the PCI interface 207 is read out (S201). The read out IP packet is expanded in the IP packet expansion means 208, and then the UDP packet is obtained. UDP packet expansion processing is performed in the UDP packet expansion means 209, and the RTP packet is obtained (S202). In an RTP packet expansion processing means, arrived packets are rearranged in order of sequence numbers which are stored as header information of the RTP packet (S203). Further, MPEG transport stream data as real data for a payload of the RTP packet are input to an MPEG demultiplexer 211 in order of the RTP packets which are rearranged (S204). Decoding (decode) processing is performed in the MPEG video decoder 212 and the MPEG audio decoder 213, and then the display 13 and the speaker 14 reproduce.

In this way, it comes to be possible to reproduce picture (voice) data by employing the sequence numbers of the RTP packets. At this point, though packet processing using UDP is explained in the processing flows of FIGS. 13 and 14, it is possible to perform the same process if the packet is formed using TCP.

Further, though the case of the aforementioned data transmitting procedure has been explained using MPEG compressed data as an example, it is possible to perform data transmission by adding the same priority as the aforementioned priority in the case in which not only MPEG data but also a series of data composed of data having different importance are packetized and transmitted.

For the method of setting the importance degree of data, there is a method in which the I picture having another picture's referencing information is set to have the highest priority and data not having referencing information to another picture in the same way as the B picture are set to have the low priority, as well as the I picture, the P picture, and the B picture for MPEG. Further, it may be possible to set 3 or more priorities in accordance with the data structure in the packet as described before.

In this way, by transmitting by setting the priority in accordance with the data types to data for transmitting by way of the network, data having important information (reference information, for example) are processed in a high priority manner. Thus, it comes to be possible to lower possibility of occurring such an error as impossibility of reproducing, for processing in the side of data transmission.

In the foregoing description, the present invention is explained with reference to the specific embodiments. It is obvious, however, for a person having ordinary skill in the art to perform substitution and/or modification to the aforementioned embodiment within the scope of not excluding the purport of the present invention . That is to say, the present invention is disclosed using exemplary embodiments, and thus it is prohibited to comprehend in a limited manner. In order to judge the purport of the present invention, the description as set forth in “What is claimed is” should be referred

What is claimed is:

1. A data transmitting apparatus, comprising:
packet generating means for generating transmitting data as a packet conforming to a communications protocol;
wherein said packet generating means performs packet generating processing by identifying an importance degree of data stored in each packet and setting priority information in accordance with said importance degree to be identified in header information.

2. A data transmitting apparatus as claimed in claim 1, wherein said packet generating means sets said importance degree of data, in which high priority information is set to data containing reference information from other data as data having high importance degree and low priority information is set to data not containing reference information from other data as data having low importance degree.

3. A data transmitting apparatus as claimed in claim 1, wherein data to be stored in a packet generated by said packet generating means are MPEG data; and
said packet generating means performs packet generating processing by setting priority information, which indicates which one of I picture, P picture, and B picture forming MPEG data is contained in data stored in each data packet, in header information.

4. A data transmitting apparatus as claimed in claim 1, wherein said packet generating means performs IP packet generating processing by setting priority information in accordance with importance degree of data stored in each IP packet in a priority information setting field of an IP header conforming to IP (Internet Protocol).

5. A data transmitting apparatus as claimed in claim 1, wherein priority information to be set by said packet generating means corresponds to service quality conforming to QoS (Quality of Service).

6. A data transmitting apparatus as claimed in claim 1, wherein priority information to be set by said packet generating means corresponds to a selecting standard of any one of a guarantee type for band width assurance data transmission and a best effort type for band width non-assurance data transmission.

7. A data transmitting method, comprising:
a packet generating step for generating transmitting data as a packet conforming to a communications protocol;
wherein said packet generating step executes a procedure of identifying importance degree of data stored in each packet and setting priority information in accordance with said importance degree being identified in header information.

8. A data transmitting method as claimed in claim 7, wherein said packet generating step defines importance degree of said data, in which high priority information is set to data containing reference information from other data as data having high importance degree and low priority information is set to data not containing reference information from other data as data having low importance degree.

9. A data transmitting method as claimed in claim 7, wherein data to be stored in a packet generated by said packet generating step are MPEG data; and
said packet generating step executes packet generating processing by setting priority information, which indicates which one of I picture, P picture, and B picture forming MPEG data is contained in data stored in each data packet, in header information.

10. A data transmitting method as claimed in claim 7, wherein said packet generating step executes IP packet generating processing by setting priority information in accordance with importance degree of data stored in each IP packet in a priority information setting field of an IP header conforming to IP (Internet Protocol).

11. A data transmitting method as claimed in claim 7, wherein priority information to be set by said packet generating step corresponds to service quality conforming to QoS (Quality of Service).

12. A data transmitting method as claimed in claim 7, wherein priority information to be set by said packet generating step corresponds to a selecting standard of any one of a guarantee type for band width assurance data transmission and a best effort type for band width non-assurance data transmission.

13. A program recording medium for providing a computer program for executing data transmitting processing on a computer system, said computer program comprising:
a packet generating step for generating transmitting data as a packet conforming to a communications protocol;
wherein said packet generating step contains a step of identifying importance degree of data stored in each packet and setting priority information in accordance with the identified importance degree in header information.
